(19) United States
(12) Patent Application Publication
(10) Pub. No.: US 2008/0144634 A1
(43) Pub. Date: Jun. 19, 2008

(54) Selective passive address resolution learning

(75) Inventors: Raveendra Chamarajanagar, Mountain View, CA (US); Peter Hunt, Sunnyvale, CA (US); Scott Kimble, Sunnyvale, CA (US); Tuyen Nguyen, San Ramon, CA (US); Giritharan Rashiyamany, Mountain View, CA (US)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: Nokia Corporation

(21) Appl. No.: 11/639,422

(22) Filed: Dec. 15, 2006

(51) Int. Cl. H04L 12/56

(52) U.S. Cl. 370/397

(57) ABSTRACT

Selective passive address resolution protocol (ARP) learning can provide a passive mechanism to synchronize link layer adjacency information among network elements. Selective passive ARP learning can be implemented by a modification to the ARP requests processing of the standby node, with a filter list containing a set of match rules for target network addresses. The implementation, thus, can be a configurable filter that enables software modules to specify a set of internet protocol (IP) addresses that the ARP input engine should monitor.

### BACKGROUND OF THE INVENTION

1. Field of the Invention

Selective passive address resolution protocol (ARP) learning can provide a passive mechanism to synchronize link layer adjacency information among network elements. Selective passive ARP learning can be implemented by a modification to the ARP requests processing of the standby node, with a filter list containing a set of match rules for target network addresses. The implementation, thus, can be a configurable filter that enables software modules to specify a set of internet protocol (IP) addresses that the ARP input engine should monitor.

ARP requests can be sent to a broadcast address, so all adjacent nodes receive them. However, they will normally discard them unless the target address matches one of their network addresses on the network. A node implementing certain embodiments of the invention will, in addition to conventional ARP request processing, attempt to match the target network address against rules in its filter list. Thus, when the node receives an ARP request message, it matches the target network address in the message against the rules in the filter list. If a rule matches, the network node updates its ARP cache with the sender network address and sender link address contained in the ARP request.

2. Description of the Related Art

In a typical network, a network element needs link-layer adjacency information to communicate with its neighbors over a broadcast medium. For example, a network element on an Ethernet network must learn its neighbor's media access control (MAC) address to send data to it. Network elements can use an Address Resolution Protocol (ARP) to obtain a neighbor's link-layer address from its network-layer address. The network element that desires information about its neighbor can broadcast an ARP request message. The broadcast ARP request message can contain the neighbor's network address and its own network-layer and link-layer addresses, to all adjacent network elements. The neighbor with the corresponding network address can send an ARP reply message, containing its link-layer address, back to the requestor. The requestor can store the information in an ARP cache. The neighbor may optionally store the requestor's network-layer and link-layer addresses from the request in its own cache, for later use.

Thus, a network element can obtain adjacency information about its neighbor via the ARP protocol in at least two ways:

1) it can receive an ARP request for one of its network addresses from the neighbor. The network element may then add an ARP entry from the neighbor's address information in the request; or [2) it can broadcast an ARP request for the neighbor's network address and receive a reply containing the neighbor's link address.

ARP is currently used by all kinds of network elements, including (but not limited to) servers, routers, network attached storage, security appliances, and the like. The invention described below, thus, can be used in any network environment where ARP is used. Further details about an ARP protocol can be found in “An Ethernet Address Resolution Protocol,” David C. Plummer, RFC 826, November 1982.

Address Resolution Protocol is the name of an Internet Engineering Task Force (IETF) standard that provides an address resolution protocol, and which is described in RFC-826. Address Resolution Protocol enables a network element to determine the link-layer address of a link adjacent network element when only the network address is known.

The network address is typically internet protocol (IP). The Internet Protocol is an IETF standard that provides an internet protocol and has two significant versions, IPv4 and IPv6. The latest IPv4 is described in RFC-791. The latest IPv6 is described in RFC-2460. Internet Protocol is a network layer protocol that provides globally unique addressing across physical networks. An Internet Protocol Address is globally unique address that is used to identify network elements on different networks. The Internet Protocol address format is dependent on the Internet Protocol version.

The link address is typically Ethernet. Ethernet is an Institute of Electrical and Electronics Engineers (IEEE) standard and is described in IEEE 802.3. Ethernet is a frame based network protocol for local area networks and provides a means of uniquely addressing stations on the local area network. An Ethernet address can also be referred to as a Media Access Control (MAC) address. An Ethernet address is globally unique and used to address stations on the same physical network.

A cluster of elements can be used in certain circumstances. A cluster is one or more elements working together, often to provide load balancing and/or high availability of a service. Proxy ARP is a method in which one network element responds to ARP request on behalf of another network element. It is typically used by bridges and gateways to route between networks on different networks without the need for a routing protocol.

The Virtual Router Redundancy Protocol is an IETF standard and defined in RFC-3768. Virtual Router Redundancy Protocol provides increased availability of network elements that serve as default routers for networks. The protocol defines an election process by which these elements select an active node to provide the next hop service. All other participating elements are standby nodes. Should the active node fail, the standby nodes will elect a new active node.

High Availability (HA) is a method to increase the ability of a service to withstand failure. HA can be deployed as a set of redundant service nodes. There are many approaches to HA configurations. One example of HA is Active-Standby. Active-Standby illustrates the mechanics of HA, but is not the only implementation. In Active-Standby, one of the service nodes can be active and provide the service. The remaining service nodes can be standby nodes ready to assume the active role should the active node fail. When the active node fails, the standby node can be expected to take over as quickly and completely as possible to minimize disruption of the service. This situation is referred to as a failover.

The phrase “failed active node” is used to designate an active node that has failed. The phrase “newly active node” is used to designate a standby node that has transitioned to active node.

An optimal failover occurs when the active node and the standby node have the same set of information. However, link-layer adjacency information tends to differ between active and standby nodes; link-layer adjacency information is acquired on an as-needed basis, and standby nodes tend not to communicate with neighbors.

As noted above, network elements can use ARP to obtain a neighbor's link-layer address from its network-layer address. The inventors have recognized that, at present, ARP does not provide a mechanism to distribute learned link-layer adjacency. When an active node in a highly available configuration fails, the link-layer adjacency it learned is lost. Before a newly active node can provide the same level of service as the failed active node, it can be required to learn the same set of link-layer adjacencies as the failed active node had.

The present inventors have recognized that this learning process can lead to a service delay until the newly active node regains that information. Additionally, the network can be burdened by a flurry of ARP request/reply transactions while the newly active node repopulates its ARP cache.

The present inventors have also recognized that a similar issue exists in an active-active high availability configuration, in which the nodes are communicating with different neighbors, and therefore have different ARP cache contents. If one node fails, the node that assumes its share of the network service burden must reacquire the failed node's link-layer adjacency information. Such a node is thus functionally equivalent to a “standby node” in the active/standby configuration.

### SUMMARY OF THE INVENTION

One embodiment of the present invention is a method. The method includes receiving an address resolution request from a neighbor node of an active node. The method also includes updating an address resolution cache based on information in the request when the request meets a predetermined condition. The method additionally includes assuming responsibilities of the active node when the active node fails.

Another embodiment of the present invention can be a network element. The network element includes reception means for receiving an address resolution request from a neighbor node of an active node. The network element also includes update means for updating storage means for storing address resolution information based on information in the request when the request meets a predetermined condition. The predetermined condition can include at least one of the request is directed to the active node or the request is from a previously unknown neighbor node of the active node. The network element additionally includes processor means for assuming responsibilities of the active node when the active node fails.

A further embodiment of the present invention can also be a network element. The network element includes a processor and a cache. The processor is configured to receive an address resolution request from a neighbor node of an active node. The processor is configured to update the cache based on information in the request when the request meets a predetermined condition. The predetermined condition can include at least one of the request is directed to the active node or the request is from a previously unknown neighbor node of the active node. The processor is also configured to assume responsibilities of the active node when the active node fails.

Another embodiment of the present invention is a system. The system includes an active node, a standby node, and a plurality of neighbor nodes to the active node. The standby node is configured to update an address resolution cache based on address resolution requests sent by a neighbor node of the active node, when the address resolution requests meet a predetermined condition.

A further embodiment of the present invention is a computer program embodied on a computer readable medium, encoding instructions that are configured to cause a hardware device to perform a method. The method includes receiving an address resolution request from a neighbor node of an active node. The method also includes updating an address resolution cache based on information in the request when the request meets a predetermined condition. The method additionally includes assuming responsibilities of the active node when the active node fails.

### BRIEF DESCRIPTION OF THE DRAWINGS

For proper understanding of the invention, reference should be made to the accompanying drawings, wherein:

FIG. 1 illustrates the infrastructure of a high availability configured gateway to which the present invention may be applied.

FIG. 2 illustrates a system according to an embodiment of the present application.

FIG. 3 illustrates a method according to one embodiment of the present invention.

FIG. 4A illustrates a network element according to an embodiment of the present invention.

FIG. 4B illustrates another network element according another embodiment of the present invention.

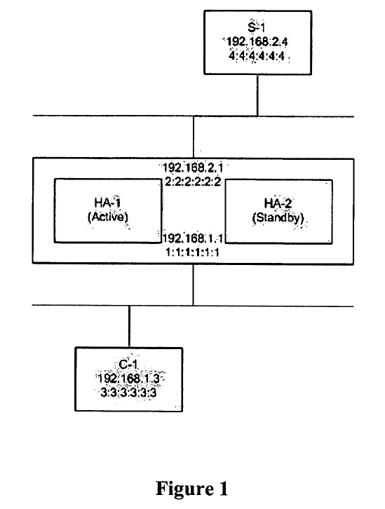

### DETAILED DESCRIPTION OF THE PREFERRED EMBODIMENTS

As mentioned above, there are two typical methods by which a node can use Address Resolution Protocol (ARP) to learn peer network address to peer link address mappings—by receiving ARP requests for its addresses from neighbors, or by sending ARP requests to neighbors. In a high availability configuration, a standby node can acquire the active node's adjacency information using an ARP request mirroring technique (such as is disclosed in the concurrently filed application, titled “Address Resolution Request Mirroring,” which is not prior art), but this may require the standby node to send requests. Selective passive ARP learning, as described in more detail below, can enable a standby node to acquire adjacency information that the active node learns in a passive manner.

Thus, certain embodiments of the invention can enable a highly available node operating in standby mode to passively learn the same set of link layer adjacencies as the active mode. Should the active node fail, the standby node would not be delayed in providing service, since it already has the link layer adjacency of all peers receiving service from the now failed active node.

Certain embodiments of the present invention enable ARP cache synchronization when the neighbor nodes of an active node issue the initial ARP request. Thus, certain embodiments of the present invention can constitute a modification to the ARP requests processing of the standby node, with a filter list containing a set of match rules for target network addresses target. When the standby node receives an ARP request message, it can match the target network address in the message against the rules in the filter list. If a rule matches, the network node can search its own ARP cache for an entry matching the target network address in the request. If it has no ARP entry in its cache, or if the entry is incomplete, the node can use the information from the ARP request to supplement the cache.

Certain embodiments of the present invention can provide value to highly available systems that rely on minimal service disruption when an active node fails and a standby node transitions to active node. Further, the present invention can be implemented without requiring changes to the existing address resolution protocol.

Certain embodiments of the present invention can provide ARP cache synchronization between active node and standby nodes for a select set of network and/or link addresses. Because the ARP caches can be synchronized, the network can avoid being loaded with ARP request/reply transactions that would be required for the newly active node to learn the link-layer adjacency of peer nodes. Thus, certain embodiments of the present invention can enable the newly active node to operate at capacity without delay.

Certain embodiments of the present invention can be selective, thereby reducing the set of ARP cache entries learned to the set of network and/or link addresses specified in the match rules.

Because no change to the ARP protocol may be required, operators can upgrade their standby node and obtain full benefit after one ARP life cycle. In environments configured with an active node that never operates as a standby node, the active node does not need to implement selective passive ARP learning. Typically, however, HA nodes run the same set of software.

Although certain embodiments of the present invention may require the standby node to consume additional resources to learn link-layer adjacency of peer nodes by reading an ARP request that it otherwise would discard, this should be a minimal burden to the standby node. In other words, certain embodiments may require the standby node to consume additional system resources to process and store the learned link layer adjacency of peer nodes, but this is expected to be a minimal burden to the standby node.

As noted above, when the standby node receives an ARP request message, it can match the target network address in the message against the rules in the filter list. Certain embodiments of the present invention can, thus, enable a highly available node operating in standby mode to learn the same set of link-layer adjacency as the active node. Should the active node fail, such a standby node would not be delayed in providing service, since it already has the link-layer adjacency of all peers receiving service from the now failed active node.

As described above, there are two methods by which a node can use ARP to learn peer network address to peer link address mappings—by receiving ARP requests for its addresses from neighbors, or by sending ARP requests to neighbors.

In a high availability configuration, a standby node can acquire the active node's adjacency information using a passive ARP learning technique, and such a technique may yield information the active node learned through the first method.

Certain embodiments of the present invention can enable a highly available node operating in standby mode to passively learn the same set of link layer adjacencies as the active mode. Should the active node fail, the standby node would not be delayed in providing service, since it already has the link layer adjacency of all peers receiving service from the now failed active node.

Certain embodiments of the present invention can also provide optimal address resolution protocol (ARP) cache convergence on newly active nodes. Because certain embodiments employ a passive mechanism, the network is not loaded with the additional ARP request/reply transactions that would be required for the newly active node to learn the layer two adjacency of peer nodes. Certain embodiments of the present invention, therefore, enable the newly active node to operate at capacity without delay.

Certain embodiments of the present invention are selective, which reduces the set of ARP cache entries learned passively to the set of network addresses specified in the match rules. This can minimize the resources consumed by passive ARP learning which is not selective. This selective feature of certain embodiments of the present invention may be implemented by a configurable filter that enables software modules to specify a set of internet protocol (IP) addresses that the ARP input engine should monitor in the target network address field of the ARP request message.

Certain embodiments of the invention, therefore, may be particularly useful for, but not limited to, network routing elements in a high availability configuration.

Thus, a modification to the ARP requests processing of the standby node can be made with a filter list containing a set of match rules for target network addresses. When a node receives an ARP request message, it can match the target network address in the message against the rules in the filter list. If a rule matches, the network node can update its ARP cache with the sender network address and sender link address contained in the ARP request.

The syntax and form of the match rules can depend on the network address. When the network address is IP, the match rules may select by network prefix. Typically, IP address match rules will match an entire IP address, but a rule may contain a prefix, a range, a sequence of individual addresses, or any criteria that match one or more network addresses.

A configurable filter that enables software modules to specify a set of IP addresses that the ARP input engine should monitor, thus can be provided. A node can attempt to match the target network address against rules in its filter list. The method of matching the target address against the rules depends on the network protocol address format and the semantics of the rule.

The rule contents may include, but not be limited to, a single address, an address range, a prefix or bit mask, a sequence of addresses, or any criteria that match one or more network addresses. An implementation may set or change the ordering of the filter rules according to, for example, priority, specificity, or heuristics that improve performance.

When an ARP request arrives and the target address matches a filter rule, the node can update its ARP cache to include an entry that maps the sender's network address to the sender's link layer address.

These entries may be implanted in a manner that is indistinguishable from ARP entries learned from an ARP reply to an ARP request. The node can use these entries to send data to neighbors any time after they are added, and they can have the same semantics as other ARP entries with respect to timeout and refresh. However, other implementations may handle this differently, if desired.

In an HA configuration, the filter can, but is to required to, contain rules that match a set of virtual network addresses shared by highly available nodes. The active node uses virtual network addresses to communicate to its neighbors and to systems on other networks. By adding the virtual addresses as exact match filter rules on the standby node implementing this invention, the standby node can learn the link layer information of any neighbor sending an ARP request for a virtual address to the active node.

Accordingly, certain embodiments of the present invention can provide value to highly available systems that rely on minimal service disruption when an active node fails and a standby node transitions to active node. Examples include, but are not limited to, network clusters and VRRP routers.

Although the description below uses IP as the network address and Ethernet as the link address for simplicity, the invention is not limited to those example embodiments.

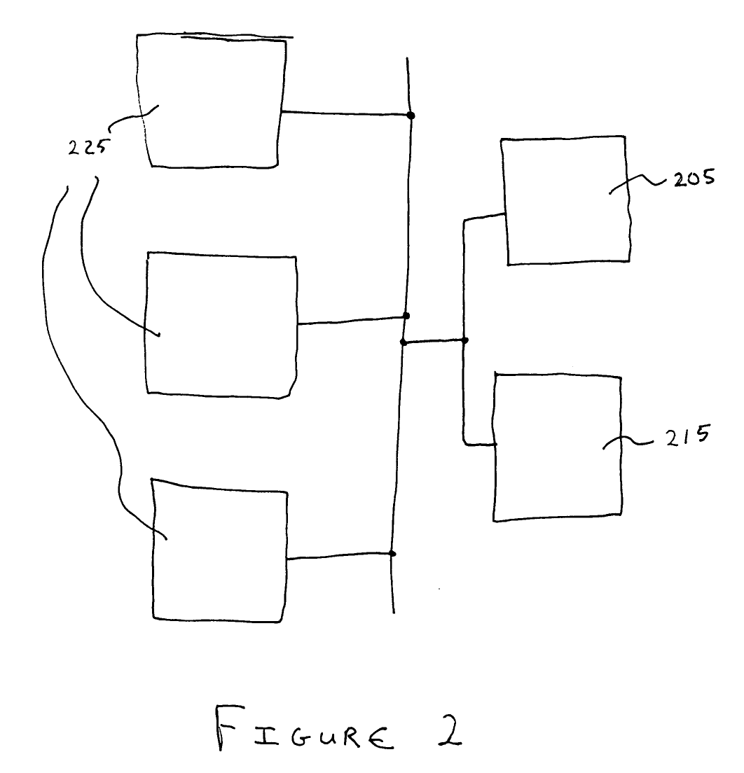

FIG. 2 illustrates a typical VRRP configuration in which an embodiment of the present invention is implemented. In this figure, the highly available network nodes, HA-1 and HA-2, are providing a gateway service between networks. The network node C-1 is configured to use the IP address 192.168.1.1 when it needs to communicate with network node S-1.

In this example, C-1 is sending a request to S-1 and S-1 is responding to C-1. First, C-1 broadcasts an ARP request in order to learn the link address associated with 192.181.1.1. The ARP request has the following characteristics:

sender link address: 3:3:3:3:3:3

sender network address: 192.168.1.3

target link address: 00:00:00:00:00:00

target network address: 192.168.1.1

Both HA-1 and HA-2 receive the packet. HA-1 replies because it is the active node. Conventionally, HA-2 would drop the packet because it is the standby node. The ARP reply has the following characteristics.

sender link address: 1:1:1:1:1:1

sender network address: 192.168.1.1

target link address: 3:3:3:3:3:3

target network address: 192.168.1.3

After this exchange, both HA-1 and C-1 have exchanged link layer adjacency and each has an ARP cache entry mapping the learned network address to link address of the other.

C-1 next transmits the request to S-1. For simplicity, discussion of the symmetrical ARP exchange between S-1, HA-1, and HA-2 are omitted.

Now suppose that HA-1 fails after passing the request to S-1 and before S-1 transmits the reply. At this point HA-2 will become active. S-1 will transmit the reply to HA-2 and since HA-2 has not, in the conventional case, exchanged link layer adjacency with C-1, it will need to send an ARP request as described above and wait for an ARP reply from C-1. Only then may it forward the response from S-1 to C-1. The exchange looks like:

ARP request

sender link address: 1:1:1:1:1:1

sender network address: 192.168.1.1

target link address: 00:00:00:00:00:00

target network address: 192.168.1.3

ARP reply

sender link address: 3:3:3:3:3:3

sender network address: 192.168.1.3

target link address: 1:1:1:1:1:1

target network address: 192.168.1.1

Selective passive address resolution takes advantage of the initial ARP request sent by C-1 to resolve 192.168.1 and eliminates the need for the final ARP request sent by HA-2 to resolve 192.168.1.3, thus eliminating the delay incurred by the final ARP resolution.

Suppose that the match rules for HA-2 contain 1 entry and the entry is 192.168.1.1. Recall that when C-1 broadcast the initial ARP request, that HA-2 received the request. Instead of dropping the packet, HA-2 can, in one embodiment of the present invention, compare the target address to match rules and find a match. As a result, HA-2 can update its ARP cache with the mapping: 192.168.1.3=>3:3:3:3:3:3.

FIG. 2 illustrates a system according to an embodiment of the present application. The system can include an active node 205, a standby node 215, and a plurality of neighbor nodes 225 to the active node 205. The standby node 215 can be configured to passively monitor address resolution requests sent by neighbor nodes of the active node 205. The standby node 215 can also be configured to update an address resolution cache based on information in the requests, when the requests meet a predetermined condition. The predetermined condition may be that the target address is the address of the active node. The predetermined condition may be that the sender address corresponds to the address of a node previously identified as a neighbor node to the active node. The predetermined condition may be that the information is not already present in a cache of the standby node 215. The various nodes may be connected by a network, and the standby node 215 and the active node 205 may be configured as a cluster or part of a cluster.

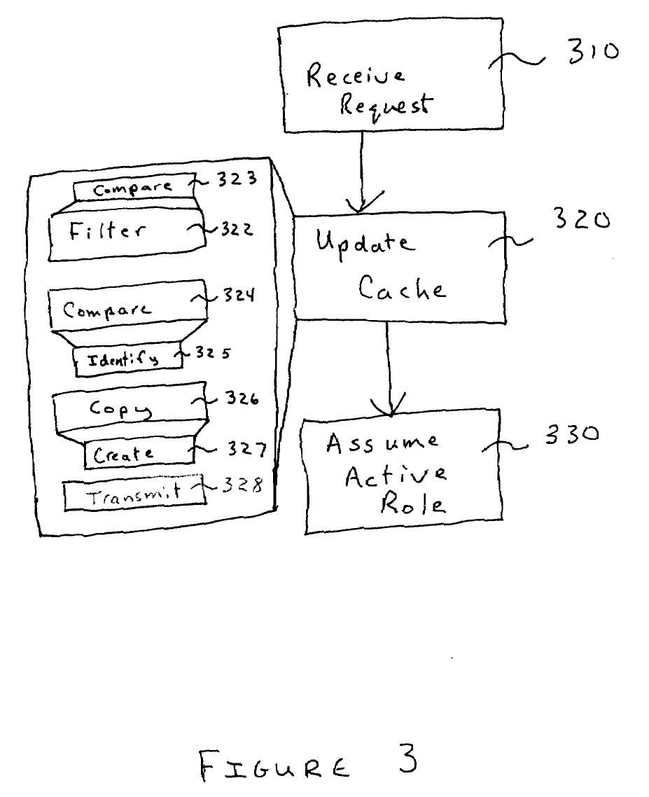

FIG. 3 illustrates a method according to one embodiment of the present invention. In the method, a standby node can receive 310 a request. The request can be an address resolution request, and can be in address resolution protocol form. The request can be a broadcast request. The request can be sent from a neighbor node of an active node, and can in certain instances, be received directly from the neighbor node.

After the request is received 310, the standby node can update 320 a cache. Updating 310 the cache can include filtering 322 the request. Filtering 322 the request can include comparing 323 the request to a filter list containing a set of match rules for at least one target network address.

Updating 310 the cache can be performed when the request meets a predetermined condition. The predetermined condition can be, for example, when the request originates from a neighbor node of the active node, when the request provides information that is unknown to the standby node, or both.

The updating 310 the cache can also include comparing 324 information in the request to information in the cache. The comparing 324 can include identifying 325 whether the information in the request is already in the cache.

The updating 310 can further include copying 326 previously unknown information from the request into the cache. The copying 326 can include creating 327 an entry in a table of the cache.

Once the cache is updated 320, the standby node can assume 330 the responsibilities of the active node. The standby node can assume 330 the responsibilities of the active node by performing a failover to become the active node. Alternatively, the standby node can assume 330 the responsibility of the active node by detecting the failure of the active node and becoming a newly active node. Once the standby node has become an active node, it may begin to transmit 328 address resolution requests in order to update 320 its cache in the normal course of cache updating for active nodes, but need not continue to monitor ARP requests from neighbor nodes. Additionally the newly active node need not update its entire cache all at once, but can commence operation as an active node without such an update.

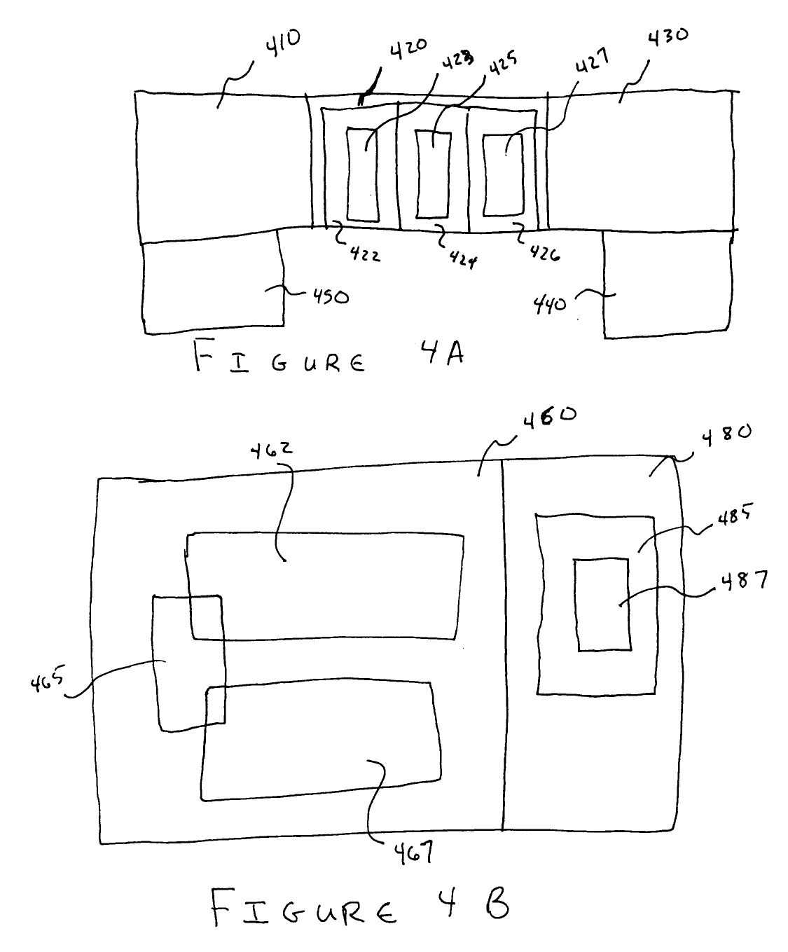

FIG. 4A illustrates a network element according to an embodiment of the present invention. The network element includes a reception module 410 for receiving an address resolution request from neighbor nodes of an active node. The network element also includes an update module 420 for updating a storage module 440 for storing address resolution information based on information in the request when the request meets a predetermined condition. The predetermined condition can be determined to exist when, for example, the request targets the active node, the request seeks information that is unknown to the network element, or both. The network element further includes a processor module 430 for assuming responsibilities of the active node when the active node fails.

The various modules can be implemented in software, hardware, or a combination thereof. Any software can be implemented on or with underlying hardware that is configured to be responsive to the software instructions and to perform the functions called for by the software. The hardware can, for example, be a general purpose computer, or an application specific integrated circuit. The network element itself can be implemented in hardware alone, or hardware combined with software. The storage module 440 may be a cache, and may implemented by a computer-readable medium including, for example, a random access memory, a hard disk, a flash disk, or a memory stick.

The reception module 410 can be configured to receive a broadcast address resolution request. The reception module 410 can also be configured to receive an address resolution protocol formatted request. The reception module 410 can additionally be configured to receive the address resolution request directly from the neighbor node.

The update module 420 can include a filtering module 422 for filtering the request. The filtering module 422 can include a first comparison module 423 for comparing the request to a filter list containing a set of match rules for at least one target network address. The update module 422 can also include a second comparison module 424 for comparing information in the request to information in the storage module 440. The second comparison module 424 can include an identification module 425 for identifying whether the information in the request is already in the storage module 440. The update module 422 can include a copy module 426 for copying previously unknown information from the request into the storage module 440. The copy module 426 can include a creation module 427 for creating an entry in a table of the storage module 440. The creation module 427 may be configured to create a mapping in the cache. The creation module 427 can be configured to associate a network address with a link address.

The processor module 430 can be configured to assume the responsibilities of the active node by performing a failover to become the active node, or by detecting the failure of the active node and becoming a newly active node.

The network element also includes a transmit module 450 for sending an address resolution request. The transmit module 450 may be inactive while the network element is in standby mode, but may become active when the network element assumes the responsibilities of the active node.

FIG. 4B illustrates another network element according another embodiment of the present invention. The network element includes a processor 460 and memory 480. The memory 480 can include instructions for the processor, as well as various caches. The memory 480 can be implemented as a single memory unit, such as a disk drive, or may be implemented by multiple memory units such as various memory chips, and may be logically organized as a single or multiple memory elements. Memory 480 may include a cache 485, which may include a table 487.

Processor 460 may include both hardware 462 and software 467. Processor 460 may also include a filter 465 implemented in hardware 463 and/or software 467. The filter 465 may be configured to filter the request by comparing the request to a filter list containing a set of match rules for at least one target network address.

The processor 460 may be configured to receive an address resolution request from a neighbor node of an active node.

The processor 460 may be configured to update the cache based on information in the request when the request meets a predetermined condition. The predetermined condition can be met, for example, when the request is directed to the active node, the request is from a previously unknown neighbor node of the active node, or both. The processor 460 may also be configured to assume responsibilities of the active node when the active node fails.

The processor 460 can also be configured to receive a broadcast address resolution request. The processor 460 can further be configured to receive an address resolution protocol formatted request. The processor 460 can additionally be configured to receive the address resolution request directly from the neighbor node.

The processor 460 can be configured to compare information in the request to information in the cache. The processor 460 can also be configured to compare the information in the request by identifying whether the information in the request is already in the cache. The processor 460 can further be configured to copy previously unknown information from the request into the cache. The processor 460 can also be configured to copy the previously unknown information into the cache by creating an entry in a table of the cache. The processor 460 can be configured to copy the previously unknown information into the cache by creating a mapping in the cache. The mapping can be configured to associate a network address with a link address.

The processor 460 can be configured to assume the responsibilities of the active node by performing a failover to make the network element become the active node, or by detecting the failure of the active node and becoming a newly active node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What we claim is:

1. A method, comprising:
receiving an address resolution request from a neighbor node of an active node;
updating an address resolution cache based on information in the request when the request meets a predetermined condition; and
assuming responsibilities of the active node when the active node fails.

2. The method of claim 1, wherein the receiving the address resolution request comprises receiving a broadcast address resolution request.

3. The method of claim 1, wherein the receiving the address resolution request comprises receiving an address resolution protocol formatted request.

4. The method of claim 1, wherein the receiving the address resolution request comprises receiving the address resolution request directly from the neighbor node.

5. The method of claim 1, wherein the updating the cache comprises filtering the request.

6. The method of claim 5, wherein the filtering the request comprises comparing the request to a filter list containing a set of match rules for at least one target network address.

7. The method of claim 1, wherein the updating the cache comprises comparing information in the request to information in the cache.

8. The method of claim 7, wherein the comparing the information in the request comprises identifying whether the information in the request is already in the cache.

9. The method of claim 1, wherein the updating the cache comprises copying previously unknown information from the request into the cache.

10. The method of claim 9, wherein the copying the previously unknown information into the cache comprises creating an entry in a table of the cache.

11. The method of claim 9, wherein the copying the previously unknown information into the cache comprises creating a mapping in the cache.

12. The method of claim 1 1, wherein the creating a mapping the cache comprises associating a network address with a link address.

13. The method of claim 1, wherein the assuming the responsibilities of the active node comprises detecting the failure of the active node and becoming a newly active node.

14. The method of claim 1, further comprising:
configuring the predetermined condition to be at least one of the request is directed to the active node or the request is from a previously unknown neighbor node of the active node.

15. A network element, comprising:
reception means for receiving an address resolution request from a neighbor node of an active node;
update means for updating storage means for storing address resolution information based on information in the request when the request meets a predetermined condition, wherein the predetermined condition comprises at least one of the request is directed to the active node or the request is from a previously unknown neighbor node of the active node; and
processor means for assuming responsibilities of the active node when the active node fails.

16. The network element of claim 16, wherein the reception means is configured to receive a broadcast address resolution request.

17. The network element of claim 16, wherein the reception means is configured to receive an address resolution protocol formatted request.

18. The network element of claim 16, wherein the reception means is configured to receive the address resolution request directly from the neighbor node.

19. The network element of claim 16, wherein the update means comprises filtering means for filtering the request.

20. The network element of claim 19, wherein the filtering means comprises first comparison means for comparing the request to a filter list containing a set of match rules for at least one target network address.

21. The network element of claim 16, wherein the update means comprises second comparison means for comparing information in the request to information in the storage means.

22. The network element of claim 21, wherein the second comparison means comprises identification means for identifying whether the information in the request is already in the storage means.

23. The network element of claim 16, wherein the update means comprises copy means for copying previously unknown information from the request into the storage means.

24. The network element of claim 23, wherein the copy means comprises creation means for creating an entry in a table of the storage means.

25. The network element of claim 23, wherein the copy means comprises creation means for creating a mapping in the cache.

26. The network element of claim 25, wherein the creation means is configured to associate a network address with a link address.

27. The network element of claim 16, wherein the processor means is configured to assume the responsibilities of the active node by detecting the failure of the active node and becoming a newly active node.

28. A network element, comprising:
a processor; and
a cache,
wherein the processor is configured to receive an address resolution request from a neighbor node of an active node,
wherein the processor is configured to update the cache based on information in the request when the request meets a predetermined condition;
wherein the predetermined condition comprises at least one of the request is directed to the active node or the request is from a previously unknown neighbor node of the active node, and
wherein the processor is configured to assume responsibilities of the active node when the active node fails.

29. The network element of claim 28, wherein the processor is configured to receive a broadcast address resolution request.

30. The network element of claim 28, wherein the processor is configured to receive an address resolution protocol formatted request.

31. The network element of claim 28, wherein the processor is configured to receive the address resolution request directly from the neighbor node.

32. The network element of claim 28, wherein the processor comprises a filter configured to filter the request.

33. The network element of claim 32, wherein the filter is configured to compare the request to a filter list containing a set of match rules for at least one target network address.

34. The network element of claim 28, wherein the processor is configured to compare information in the request to information in the cache.

35. The network element of claim 34, wherein the processor is configured to compare the information in the request by identifying whether the information in the request is already in the cache.

36. The network element of claim 28, wherein the processor is configured to copy previously unknown information from the request into the cache.

37. The network element of claim 36, wherein the processor is configured to copy the previously unknown information into the cache by creating an entry in a table of the cache.

38. The network element of claim 36, wherein the processor is configured to copy the previously unknown information into the cache by creating a mapping in the cache.

39. The network element of claim 38, wherein the mapping is configured to associate a network address with a link address.

40. The network element of claim 28, wherein the processor is configured to assume the responsibilities of the active node by detecting the failure of the active node and becoming a newly active node.

41. A system, comprising:
an active node;
a plurality of neighbor nodes to the active node; and
a standby node configured to update an address resolution cache based on address resolution requests sent by a neighbor node of the active node, when the address resolution requests meet a predetermined condition.

42. A computer program embodied on a computer readable medium, encoding instructions that are configured to cause a hardware device to perform a method, comprising:
receiving an address resolution request from a neighbor node of an active node;
updating an address resolution cache based on information in the request when the request meets a predetermined condition; and
assuming responsibilities of the active node when the active node fails.
